(19) United States
(12) Patent Application Publication
(10) Pub. No.: US 2004/0117198 A1
(43) Pub. Date: Jun. 17, 2004

(54) Method to create memorable identities for entities

(76) Inventor: Donald Wayne Miller JR., Shawnee, KS (US)

Correspondence Address: Donald W Miller Jr, 13874 West 58th Place, Shawnee, KS, 66216-5400, US

(21) Appl. No.: 10/319,934

(22) Filed: Dec. 16, 2002

(51) Int. Cl. G06F 17/60

(52) U.S. Cl. 705/1; 705/7

(57) ABSTRACT

This invention provides a method to create memorable identities for entities. These identities consist of two to three word phrases that are assigned to entities whenever there is a need to enhance recall of these entities for identification purposes. This method specifies the syntax for these phrases consisting of a noun preceded by one or two adjectives and requires that such phrases elicit vivid, remarkable, and often nonsensical, ideations. This method enhances the ability of individuals to recall such memorable phrases and therefore assists in the identification of the entities to whom these identities are assigned.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention pertains to any field where identification of entities (e.g. persons, vehicles, places, equipment, etc.) is needed with a desire to improve the ability of individuals who may interact with those entities to recall their identity. There may also be a need for this identification to be anonymous, that is, not disclosing the true identity of the entity (e.g. a customer not learning the first and last name of an individual providing service to the customer) or not.

For discussion purposes, measuring the quality of service delivered by businesses and the performance of individuals employed by those businesses will be used as an example of a field where this invention may be used. This example demonstrates the improved benefit from this invention compared to those methods or lack of methods that have existed previously to identify entities.

There are entire industries that provide services to businesses that wish to obtain feedback about the performance of individuals in their employ or the overall satisfaction of the general public with their business. This feedback is important in order to identify deficiencies in the service provided by the business or to identify employed individuals in need of correction or praise. In order to collect this feedback there must be first a method to solicit feedback from customers, and second, there must be a way to reliably identify the individuals or entities who may be the subjects of study.

Soliciting feedback or satisfaction-monitoring can be accomplished in any number of ways including surveys, toll-free telephone reporting mechanisms, or lately, Internet-based reporting via commercial websites. Because of human nature, only a very small percentage of people actually take the time or make the effort to avail themselves of these methods to report satisfaction or dissatisfaction with business services. It is in the interest of the business requesting feedback to maximize the number of responses by these individuals to remove uncertainty as to the validity of the responses, and to measure the public's general degree of satisfaction with their business enterprise. It is in the interest of those businesses that provide feedback services to other businesses to remove barriers that prevent the public from providing this desirable feedback.

One of the barriers that prevents the public from self-reporting good or bad service is the inability to recall names of individuals or to recall multiple alphanumeric characters that are commonly-used to identify specific entities. In these cases, the person wishing to report something about that entity or person will likely abandon further efforts to provide feedback, and thus, even though there was intention, the opportunity is lost for the business to receive feedback about its services. For example, when a restaurant server either provided exemplary or bad service to a customer, unless the customer went to extreme lengths to either memorize the server's name or to write it down, it is unlikely that the customer will remember the server's name even an hour later when the customer may decide to report the service at his/her convenience. In another example, it is common as one travels on highways to see trucks with a decal on the rear trailer reading “How's My Driving?” along with a telephone number, and some sort of alphanumeric code such as “XD492F3L”. Again, without taking extraordinary measures (e.g. writing down the code while driving, trying to memorize the alphanumeric code by repeatedly speaking the code aloud, trying to place a phone call at the same time as driving, etc.) it is likely that even 10 minutes later the driver of the car behind the truck will be unable to accurately recall the cryptic identification code displayed on the truck trailer.

In both of the examples above, an individual who is motivated to report satisfaction or dissatisfaction with service or an encounter might well abandon their efforts to do so simply because they cannot specifically remember who or what to report. When this unfortunate result occurs on a daily basis, for thousands of businesses, across an entire nation, a large amount of information is lost that is vital to business owners and executives. A method is needed to maximize the number of responses for business feedback mechanisms and to reduce or help eliminate barriers to persons wishing to participate in such mechanisms. The proposed invention specifically addresses this situation by leveraging the innate memory capabilities of human beings (as discussed below) and has the potential to dramatically improve response rates in various business feedback mechanisms.

It is well-known in the field of cognitive psychology that it is easier for human beings to remember items that have semantic meaning, are familiar, are similar to previously-encountered items, are remarkable or clever, or that elicit rich and colorful visual images. This is especially true when compared to the process of remembering random combinations of letters, number, or symbols. Further, it is known that most human beings have the capacity to easily remember 3-5“chunks” of information, and beyond that limit, their recall performance is degraded. For example, for the average person, it is easier to memorize the very memorable phrase “blue cow” versus the text “XD492F3” although they both contain the same number of characters. The “blue cow” phrase, although consisting of two words, subsumes to only one “chunk” of information (a blue cow) and at the same time elicits a particularly vivid and memorable visual image. In fact, if an individual actually makes the effort to visualize mentally a blue cow, recall is increased several orders of magnitude. On the other hand, the text “XD492F3” consists of at least seven “chunks” of information (more if order of each character was important) and lacks any familiar meaning whatsoever. “Blue cow” and the visual image it elicits is eminently more memorable than “XD492F3”.

From the perspective of the individual entity or subject being reported about, it is likely in most cases that the subject would prefer that their true identity and name would not be disclosed to customers who may comment about their service. An anonymous, but memorable phrase, as specified using this invention will satisfy that subject's preference regarding anonymity and lack of disclosure of his/her true identity to reporting customers.

By methodically creating phrases to identify entities or individuals, this invention promises to remove one of the biggest barriers (inability to specifically recall identities) to customer-reported satisfaction or dissatisfaction about services or businesses.

It is anticipated that if this invention were made public without intellectual property protection, one might quickly see obscure identification codes such as “XD492F3”, as commonly seen on highways for example, disappear, and be quickly replaced with memorable phrases such as “flying toaster”.

### BRIEF SUMMARY OF THE INVENTION

This invention describes a method to create memorable phrases useful in the identification of entities (persons, vehicles, places, etc.). The memorable phrases leverage innate human cognitive abilities for recall and are created with a prescribed syntax and a requirement that the phrases elicit particularly vivid or remarkable, and therefore, memorable mental images. These memorable phrases are assigned to entities with the benefit that successful recall of these phrases, and hence identification of those entities, will be significantly enhanced compared to commonly-used methods of identification used prior to this invention.

### BRIEF DESCRIPTION OF THE SEVERAL VIEWS OF THE DRAWING

Not Applicable.

### DETAILED DESCRIPTION OF THE INVENTION

The method for creating memorable phrases consists of first specifying the minimum and maximum number of words to be used in each memorable phrase. Because of the impact on human recall and because of the space limitations for the media for which these phrases are intended (e.g. name badges, decals, bumper stickers, business cards, labels, etc.) only two or three words are used in each memorable phrase.

Each memorable phrase shall consist of one or two adjectives followed by a noun that may, for example, name a physical object (living or inanimate) or a concept.

The adjectives in the memorable phrase may be qualified descriptors of any physical object, not just descriptive of the named object or one that makes any sense in the context of the object, as the adjectives used in the phrases commonly will not have any semantic or contextual relationship with the object named by the noun. In fact, the more absurd the adjectives are in relation to a noun used in the phrase the better, since phrases that include incongruous words or descriptors that have no relationship to the object elicit more whimsical, sometimes ridiculous, and therefore, more vivid and memorable phrases. Selection of the adjective or adjectives in each memorable phrase may be limited to those adjectives that are descriptive of visual characteristics, motion, or activities associated with physical objects. For example, adjectives such as “blue”, “tall”, “tiny”, “dancing”, “jumping”, “flying” would be useful as they are all descriptive of physical objects.

Selection of the noun in each memorable phrase may be come from nouns that describe a physical object. For example, nouns such as “cow”, “chair”, “ball” could be used as they all can elicit mental images of physical object especially in combination with adjectives that make the phrase remarkable, e.g. “bald cow”, “floating blue chair”, or “singing ball”. Concepts described by nouns, such as “thought”, “flavor”, or “business”, which could be used in such memorable phrases as “bizarre thought”, “stinking flavor”, or “funny business”.

In actual practice, in order to generate a large number of memorable phrases a list of qualified nouns and a list of qualified adjectives would be compiled and used to generate every possible phrase combination. This permutation creates a very large pool of memorable phrases that can be used for identification purposes. It is one of the goals of this method that most of the combinations created from these lists will be incongruous or even silly, and therefore, even more memorable.

Once memorable phrases are generated using this invention, they can be parsed out to businesses for use in identification of individuals or entities with enhanced recall in whatever manner is appropriate for a business.

I claim:

1. A method to create memorable identities for entities, comprising:
a) assembling phrases having two to three words, where
1) the rightmost word in said phrases is a noun, and
2) the remaining words in said phrases are adjectives, and
3) said phrases elicit vivid and remarkable ideations,
b) assigning said phrases to said entities as a method of identification for said entities,
whereby assignment of said phrases to said entities to provide said memorable identities will enhance the ability of individuals wishing to recall said entities for identification purposes.

2. The method of claim 1 wherein said rightmost word in said phrases is a noun that names any physical object and said remaining words in said phrases are adjectives descriptive of visual characteristics, motion, or activities associated with any physical object.

3. The method of claim 1 wherein said rightmost word in said phrases is a noun that names a concept and said remaining words in said phrases are adjectives that in combination with said concept elicit remarkable ideations.

4. The method of claim 1 wherein said phrases are assigned to motor vehicles as a method of identification for said motor vehicles.

5. The method of claim 1 wherein said phrases are assigned to persons providing services to the public as a method of identification for said persons.

6. The method of claim 1 wherein said phrases are assigned to buildings as a method of identification for said buildings.

7. The method of claim 1 wherein said phrases are assigned to geographic locations as a method of identification for said geographic locations.

8. The method of claim 1 wherein said phrases are assigned to equipment as a method of identification for said equipment.

9. The method of claim 1 further including assigning said phrases to said entities as a method of identification for said entities when there is a need that otherwise private identities of said entities are not disclosed.
